(19) United States
(12) Patent Application Publication
(10) Pub. No.: US 2005/0269254 A1
(43) Pub. Date: Dec. 8, 2005

(54) [Air and Water Purifying System And Filter Media]

(76) Inventor: Lipa Leon Roitman, Dayton, OH (US)

Correspondence Address: LIPA ROITMAN, 300 OTTERBEIN AVENUE, DAYTON, OH, 45406, US

(21) Appl. No.: 10/710,249

(22) Filed: Jun. 29, 2004

Related U.S. Application Data
(63) Continuation-in-part of application No. 10/709,694, filed on May 24, 2004.

(51) Int. Cl. B01D 36/00; B01D 15/00; B01D 61/00

(52) U.S. Cl. 210/252; 422/24; 422/22; 210/644; 210/175; 210/259; 210/263; 210/294; 210/200; 210/321.6

(57) ABSTRACT

Disclosed is an air-purifying, air humidifying or dehumidifying, and air cooling or heating, generating water from the atmospheric moisture, water storing, purifying, and an energy efficient distillation apparatus, which efficiently introduces fresh air indoors is disclosed, comprising of an air-to-air heat exchanger, water and air and light contacting chamber, a novel water distillation apparatus, a water filtration system, a water filtration media, a toxic chemical or biological warfare threat detector and neutralizer.

### CROSS REFERENCE TO RELATED APPLICATIONS

This application is a continuation-in-part of application Ser. No. 10/709,694, filed May 24, 2004

### BACKGROUND OF INVENTION

This invention provides a novel method and apparatus for indoor air and water purification. The novel threat of terrorism adds new dimension to our normal environmental concerns. The apparatus of this invention responds to this threat by providing a new level of security for home and office environment, and does it in a quiet and inconspicuous way as part of the normal air and water conditioning operation.

This invention discloses an apparatus and a method that is capable at the same time of 1) introducing fresh clean air from outdoors in an energy efficient way, i.e. without losing the indoor heat or cold, 2) reducing indoor air pollutants, 3) heating or cooling the indoor air, 4) removing excess humidity in hot weather and adding humidity to the indoor air in cold weather, 5) converting water condensed as a result of air conditioning action in hot and humid climates into clean potable water, 6) providing a storage reservoir for the clean drinking water, and further purifying the available water by removing by-products of chlorinating and other persistent pollutants, 7) absorbing the daytime heat and releasing it at night, 8) detecting and neutralizing chemical and biological warfare agents, 9) alarming the designated authorities of the chemical or biological threat and 10) being the integral and low-maintenance part of the total home heating and air conditioning system.

### SUMMARY OF INVENTION

The apparatus is thus disclosed at the heart of which is the air-water-catalyst-UV light contacting, air and water purifying, air heating or cooling, humidifying or dehumidifying, and oxidizing CHAMBER, with water circulating between the CHAMBER and the PURE WATER HOLDING TANK, through the water filters, and heater/cooler, which THREAT DETECTOR monitors the air and water going through the chamber using IR spectroscopy fluorescence spectroscopy, a flame ionization detector and other sensors, and feeds the data into pattern-recognition software and the heuristic formula, which triggers the alarm and seals the indoors and activates the when threat is detected, which circulates INDOOR air and admits fresh outdoors air through the AIR-TO-AIR HEAT EXCHANGER, which also has a novel patent-pending energy-efficient self-regulating steam distillation apparatus attached to the pure water holding tank.

The apparatus filters the incoming outdoors air by passing it through the water contacting chamber, which traps the particulate pollutants in water droplets, and at the same time purifies the indoors air by recirculating it through the same chamber, The chamber provides low air resistance, unlike porous solid based filter media, The air-water contacting chamber also disinfects and oxidizes the pollutants using UV-VIS light irradiating on the water-air mixture in contact with the catalyst in the chamber, and by electrolysis, and by percolating the air-water mixture through the limestone bed, the air-water contacting chamber also serves as a heat exchanger, by heating or cooling the air through controlling the temperature of the circulating water. In this capacity it serves as a sole heat exchanger, or supplements the conventional one.

the air-water contacting chamber also serves as a humidifier or dehumidifier, through controlling the temperature of the circulating water; the cold water decreases humidity, and hot water increases it, the air-water contacting chamber, when acting as dehumidifier in hot and humid weather, condenses the water from the air as a result of cooling the water below the due point temperature, and allows converting it into clean potable water through circulating it through the water filter system along with the rest of the water, The air-water contacting chamber serves also as a part of the threat detection and neutralization loop, containing sensors

In the apparatus of this invention the water circulates through the water filter system between the water holding tank and the water contacting chamber, thus continuously purifying it. The water holding tank is connected to the municipal water system and has water level control means.

The water holding tank provides a storage reservoir for the clean drinking water for emergencies. It also collects additional water removed from the air during the dehumidification in hot and humid weather. This condensed water is combined with the rest of the water in the tank, and becomes suitable for drinking. It can capture rain water. Through a continuous recirculation through the filter, the tank water is being continuously purified.

The water holding tank also serves as a heat sink, and is sized to absorb a significant amount of heat during the day, releasing it at night. It also provides potable water storage for emergencies.

The temperature of water entering the contacting chamber is controlled by a cooling/heating system in order to control the air temperature and humidity. It cools the water entering the contacting chamber to dehumidify and cool, and heats the water to humidify and heat the passing air. Additional controls over the humidity and the temperature are provided.

Air quality sensors chemical and biological threat detectors, and means to automatically control the operation of the system which should make the indoor air and water supplies invulnerable to toxins and chemical agents are provided. In the emergency mode, when triggered by the threat detector, the system responds automatically, shutting off the indoor environment, and activating the threat neutralization loop.

Also scale removing and ductwork cleaning, deodorizing and disinfecting chemicals, and toxin and chemical warfare neutralizing chemicals are incorporated into the system.

Also an ozone-resistant filter media and a novel distillation apparatus is disclosed,

### BRIEF DESCRIPTION OF DRAWINGS

FIG. 1 through 6 show schematics of the apparatus according to the invention in different variations.

FIGS. 7 and 8 show schematics of a distillation apparatus of the invention in two of the possible embodiments.

### DETAILED DESCRIPTION

The Air Intake. The apparatus of this invention is comprising of a number of elements. One is a counter-flow principle air-to-air heat exchanger 100 connecting the outdoor and indoor air through a plurality of channels or tubes within and along the length of that heat exchanger, such as those available commercially, wherein each channel where the air flows in one direction is in contact with the channels where the air is flowing in the opposite direction, blowers 110 to move the air from indoors to outdoors through some of the channels, while simultaneously moving about the same amount of air in the opposite direction through other channels of the heat exchanger 100, means 120 to physically separate and distance the air inlets and outlets on the outdoor end of heat exchanger to prevent the re-intake of the exhausted air. The heat exchanging air duct is preferably inclined towards the indoors in order to collect the water condensed in hot humid weather.

The Chamber. An air and water contacting, air purifying, humidifying or dehumidifying, and air cooling or heating, heat exchanging chamber 200 and means of contacting the incoming air from outdoors or indoors with the falling water inside that chamber, comprising a water-impermeable chamber with air-water mixing devices or water droplets creating devices 270. The air flow resistance is a major problem with current solid mesh or web based filters, which tend to increase resistance and get plugged as dirt accumulates. Instead, the water, having low viscosity and high heat capacity is capable of trouble-free particle capture and efficient heat exchange. The inventive chamber has a wide cross-sectional area to provide the correct air velocity, and a deep packing media for increasing the water-air surface contact, and a wide cross-sectional area for the water filter to remove particles, which is also renewable by back-flushing.

The preferred designs are either crossflow (horizontal) or countercurrent (vertical) flow, of which the countercurrent vertical one is the most preferred. This solid contact media is shaped in such a way as to provide little resistance towards the air flow. Preferably it is made and shaped as individual mesh pads, encased in trays for easier replacement. In the inventive system, the particulate impurities are accumulated in the sand and limestone filters, which are more capable of retaining them without plugging, due to higher surface area. filters are also easier to clean by back-flushing the water.

The air-water chamber 200 is functionally divided into the top part 200A above the water spray level in the path of the exiting air, the middle part 200B where air and water are mixed, and the lower part of the chamber 200C where the water is pooled on the way out.

The upper part 200A contains one or more of such devices: means 201 to contain the water droplets or mist within the chamber, which may comprise of electrostatic precipitator, or a web, or a vortex, UV light source, a blower, a heat exchanger for heating or cooling the air exiting the chamber, or the entire heater/cooler system. Also, ozone sensor at the air exit end of the chamber, which gives a feedback to the control unit of ozone-generating UV-lamps and high voltage ionizer, and adjusts the ozone generator circuitry to the desired level. Also other air quality sensors.

Particulate Filter. The bottom part 200C contains filtering and percolation media 350 for trapping particulate. Alternatively, a separate enclosure or a compartment is used for the filtering media. The water filtration media can comprise of a multi-layer structure, with rocks, gravel, coarse sand, regular or partially calcined limestone, marble, chalk, dolomite, apatite, mica, clay, hydrotalcite, aluminosilicate, magnesia, or other locally available minerals containing carbonates or phosphates of calcium, magnesium or aluminum, and a water-permeable membrane or fiber bed underneath. Preferably, it is a combination of coarse sand with crushed limestone on a polypropylene fiber or glass fiber bed.

This filtering and percolation media 350 is regenerated by back-flushing. 200C has water level sensor, which activates the back-flushing cycle when the water reaches a certain level. The bottom of the water contacting chamber is also connected to a utility water source 288 or has a pump reversing switch to reverse the water flow, and a vibrator to shake the filter beds in order to dislodge the settled and trapped contaminants from the filter particles during back-flushing of the filters, with flush water draining through the valve 285, and with heating element to heat the water during the back-flushing. Also, 200C contains electrodes for electrolyzing the water that passes through, and thus disinfecting it. The electrolysis also supplies the hydrogen and oxygen mix for the flame ionization detector.

The middle part 200B of the chamber may further contain optional baffles 260, webs, rocks 280 or other like fillings to facilitate contacting the air and the water and to increase the contact surface area, water spray nozzles 270, a mixer 257 to enhance the mixing of air and water or to create a vortex within the chamber, air and water quality sensors, and (in one configuration) UV-VIS or other radiation sources. In other configurations the radiation sources are located in 200A or outside of the chamber.

Modes of Purification. The air-water contacting chamber prevents airborne or waterborne pollutants or chemical or biological agents from entering the heating, ventilation and air and water conditioning system. The air and water are purified in the chamber in one or a number of simultaneous ways:
a. The water traps the particulate and other impurities and carries them to the water filters,
b. The high voltage ionizing electrode. Air ionizer 700 in the chamber air intake path, to create an electric charge potential between the incoming air and the water in the chamber, and promotes particulate removal by electrostatic precipitation, and by breaking-up the water particles into smaller ones.
c. The high voltage ionizing electrode also creates ozone, which helps in oxidizing the pollutants and disinfecting the air and the water. Ozone rapidly reacts with metal ions within the water, forming precipitants which may be removed through filtration. Ozone within water also degenerates or causes lysis of the cell walls of bacteria, killing the bacteria. Ozone within water also beneficially oxidizes and neutralizes sulfides, nitrates, cyanides, detergents, and pesticides. Ozone gas is much more soluble within water than common air components such as nitrogen, oxygen, and carbon dioxide, and is recirculated in water solution, thus keeping the water in the holding tank sterile, and prevents biofilm formation.
d. The low voltage potential is created between the two electrodes 255 immersed in the water in the lower part of the chamber 200C. It electrolyses the water, creating ionically charged species and free radicals such as hydroxyl radicals, singlet oxygen, and other highly reactive species, which destroy organic matter and disinfect the water. Electrolysis also converts chloride ions in water to disinfecting chlorine, etc. (See: Philip S. Stewart, Wanida Wattanakaroon, Lu Goodrum, 1 Susana M. Fortun, and Bruce R. McLeod, Electrolytic Generation of Oxygen Partially Explains Electrical Enhancement of Tobramycin Efficacy against Pseudomonas aeruginosa Biofilm in Antimicrobial Agents and Chemotherapy, February 1999, p. 292-296, Vol. 43). Electrolysis also reduces toxic metal ions like lead salts to the insoluble in water metal form, and reduces perchlorates to chlorine. In one option one or both electrodes are made as fibers and other fillers 260, and serve also to increase the air-water surface area. Electrolysis also flocculates microscopic particulate into larger easily filterable particles. Electrolysis also produces hydrogen and oxygen gases necessary to operate the flame ionization detector 256. Electrolysis electrodes 255 can be connected to the source of direct or alternating current. The anode, the oxidizing electrode, which generates oxygen and protons from water, and chlorine from chloride ions is above, and the cathode, the reducing electrode, which generates hydrogen and reduces dissolved oxygen and chlorine to hydroxyl and chloride, is below, in the path of water towards the water tank. The electrodes can be made of graphite, platinum, iron, ferrite iron, or other conventional electrode material, but preferably, made of silver, copper, or other metals, which gradually dissolve on the application of electric charge, releasing anti-septic quantities of reactive oxygen intermediates, and ions of Ag++, Cu++, etc. The electrodes can be arranged as vertical mesh plates, horizontal mesh plates, of concentrical cylinders, or in any other way, and can be of rod, plate or other shape. A trap of gas is set above the electrods, to collect the hydrogen and oxygen gases formed during the electrolysis, and forward them towards the flame ionization detector, located in the air intake path.
e. The UV light activates the oxidation of impurities by oxygen in the air, which is facilitated by the baffles, webs, etc. 260, made of UV-catalysts and UV-sensitizers, such as these based on titania or doped titania or similar materials, and preferably is made in the form of nano-particles or nano-film deposited on the surface of the UV-transparent or reflective solid media. The UV light also creates ozone and other highly reactive species. Alternatives to the UV-VIS lights could be the electron beam, X-rays or gamma-rays or other ionizing radiation sources.

The solid contact media. The solid contact media is preferably made from UV-transparent or reflecting media, like the optical silica glass fibers, or polished metal, and shaped in loosely packed webs. It can be packed in coils, woven as cloth, randomly packed, or any other three-dimensional shape. In one configuration the fibers are branching off from a central elongated tube containing the UV-lamp. In another configuration the fibers are hollow. In still another configuration the filler are beads arranged either as free hanging beads suspended from a string or free floating beads, or randomly or orderly packed beads. If the filling is made of conducting material like metal, graphite, etc., it can serve as an electrode for introducing high-voltage potential between the air and the water phase, or for a low-voltage potential for electrolysis of the water phase.

The media that facilitates the contact of air and water in the air-water contacting chamber also preferably serves as photo-oxidation catalyst, and is preferably made of macro, micro or nano-fibers, or from macro, micro or nano-particle-based photo-oxidation catalysts, supported on the UV-transparent silica fibers such as the fibers made by Polymicro Technologies (Polymicro Technologies, LLC, Phoenix, Ariz.). The choice of the silica fibers is for three reasons: 1. UV-transparency of the support media is very important for the efficiency of the UV-induced process, 2. Such fibers can be arranged into three-dimensional structures with high surface area and high permeability of water and air, 3. These fibers can also be used as light probes for the spectroscopic threat detection.

The air-water contacting chamber may also be a part of a chemical and biological threat detector based on IR spectroscopy and fluorescence spectroscopy and other instrumental methods and sensors such as flame ionization detector (FID), pH and conductivity sensors, that feeds the data into the neural networks-based pattern-recognition software and the heuristic formula, which triggers the alarm and seals the indoors and activates the decontamination module when threat is detected,

The air circulation path comprises a vent and the valve 210 for the air incoming from the outdoors through the heat exchanger 100, a vent and the valve 220 for the incoming recirculating indoors air, or three-way vent and a three-way valve, allowing variable mixing of outdoor and the indoor air entering the chamber, a vent 250 for the air exiting the chamber towards indoors or towards the air distributing ductwork, means to move the air through the chamber, which could be an electric fan, or a fan powered by the stream of water going through the chamber, or venturi-effect air-pumping device powered by the water stream, the water dispersion nozzles in the chamber receive water from the tank 300 through the water heater/cooler 360.

The water circulation loop powered by a pump 356 comprises of a water dispersion head, water filter 350 for removing particulate and other contaminants from the circulating water, a valve connection 240 for the outgoing water from the chamber, which connects in turn to the water filter 355, which connects in turn to the water tank 300, which connects in turn to the water heater or cooler, then back to the chamber where it is sprayed through the 270 spray heads. A water tank 300, and a utility water source 310 connection, with means to control the water level in the tank 320, which could comprise of one or more of floating flap valve, like the one used to control the water level in a common toilet tank.

Heater/cooler means 360 to cool or heat the water flowing from the tank into the contacting chamber 200 using electric, gas, oil, or other fossil fuel, solar energy, heat-pump, or another method.

Dispersion Head Means 270 of dispersing or pulverizing the water to create a mist or contacting of water particles within the chamber, or both. In one embodiment it can comprise of Venturi-effect contacting head, in another an ultrasonic spray device, in another a rotor-stator disperser device, or a device using electrostatic charge to break-up the spray particles, or a regular “shower” head using water pressure. The droplet size can be controlled through different means of dispersion. The spraying head can be mounted on a bearing in an off-set way, to make it free spinning under the reactive force of the water jet, when the water is on. Otherwise a water-dispersing function is accomplished by a solid dispersing media in the chamber.

The Temperature Control. The room temperature thermostat controls the water heater/cooler operation. The temperature of water entering the contacting chamber is determines the air temperature and humidity. It cools the water entering the contacting chamber to dehumidify and cool, and heats the water to humidify and heat the passing air.

To decouple the humidity control from the heating or cooling controls, a valve or two valves controlled by a humidity controller split the water stream before entering the chamber in two, with one stream going directly to the water-dispersing nozzles 270 in the chamber, and another stream going through the heat exchanger 365 in the path of the air exiting the chamber, and then to the nozzles in the chamber. To increase the humidity more water is run directly to the chamber, and less through the heat exchanger, and vice versa. Thus if one desires a dry heat, more hot water is run through the heat exchanger, and less directly to the chamber. Thus the heat is transferred from water to air without direct contact, and the already cooler water enters the chamber, which reduces evaporation. Likewise, if one desired a dry cool air, more cold water is run through the coil, and less directly to the chamber. Thus the cold heat exchanger serves as a condenser, condensing the water from the air exiting the chamber, with the said heat exchanger having a provision (a wick or a channel for collecting the distilled water condensate into a separate vessel 251.

Mixer 257 to enhance the mixing of air and water or to create a vortex within the chamber, means to contain such water mist within the chamber, an optional limestone or other mineral filling in the 200B section of the chamber for percolating the air-water mixture through it, which percolation emulates the water purification process in the nature. Another embodiment has the spinning contact media, shaped to mix and propel the air.

In the preferred embodiment the water filtration system 350 is located on the bottom of a water contacting chamber, and is made to be an integral part of it.

In the preferred embodiment the water filtration system 350 is located above or on top of the water holding tank.

In yet another alternative embodiment the water filtration system is located on a bottom of a water contacting chamber, which is above or sits on top of a water holding tank, and is optionally made to be an integral part of it.

In another embodiment the water heater and cooler are made integral with the air to air heat exchanger, and are located near the outside wall, with some parts located inside and other parts outside, as necessary for air conditioning and heat pump systems. In another embodiment the water heater and cooler are located near the outside wall.

In yet another embodiment the air/heat exchanger, water contacting chamber, the water filtration system, water heater and cooler and other devices are all made integral with each other.

Additional Filter Media. Activated carbon, reverse osmosis or any other known filter can be used to filter the water after the particulate is removed. Special filters can be used to remove specific undesirable contaminants present in the local municipal water or in the air (dissolved salts, halogenated contaminants, arsenic, lead, perchlorate, etc.) In the preferred embodiment it has capability for regenerating by back-flushing, or by other means.

Filers suitable for such filtration purpose, when no ozone is entering the filter in significant quantities, are the novel ionically modified polymers derived from cellulose, crosslinked starch, chitine and chitosan, or other polysaccharides, that have a capacity for ion exchange. The water-permeable membrane or fiber filter beds for purification or filtration of water are obtained by cyanopropylation of cellulose films or fibers by addition of aqueous NaOH to cellulose suspended in acrylonitrile, followed by reduction, esp. hydrogenation, which converts the nitrile group to amine. The amine such formed can be further quaternized by alkylation with methyl iodide, dimethyl sulphate and other alkylating agents. The polymers are optionally further modified by addition of bromine water to oxidize the C(6)-carbinol to carboxyl group. Alternatively, such amino-functional cellulose and carboxy-functional one, like carboxymethyl cellulose CMC can be made separately and mixed together to make a filter. Still another possibility is to use crosslinked CMC as a substrate for introduction of cationic side groups. Such zwitterionic polymers act as ion exchange polymers, and are effective in removing ionic impurities, such as partially oxidized pollutants from water, perchlorate, lead, cadmium and arsenic. Alternatively, other known or commercially available polymers can be used.

The zwitterionically modified fibers or films can also be made by reacting polyaziridine or polyvinylpyridine or ethylenediamine with carboxymethyl cellulose, and heating to crosslink, then reacting with the alkylating agent, or by reacting polyaziridine or polyvinylpyridine or ethylenediamine with the alkylating agent, followed by mixing with carboxymethyl cellulose and heating to crosslink

Alternative route to such ionically modified polymers is by the reaction of films or fibers from cellulose, starch, carboxymethylcellulose, and other natural or modified polysaccharides with (a) toluenesulphonyl chloride, thionyl chloride, or phosphorous oxychloride, followed by (b) the hydrohalogenation to obtain halogen-modified polysaccharides, followed by (c) amination with ammonia or amines, to obtain amino-functional polysaccharides, followed by (d) quaternization with methyl iodide, dimethyl sulphate, 2-chloroacetic acid, or other alkylating agents or mixtures of agents.

The polymers thus obtained are optionally further modified by addition of bromine water to oxidize the C(6)carbinol to carboxyl group. Alternatively, such amino-functional cellulose and carboxy-functional one, like carboxymethyl cellulose CMC can be made separately and mixed together to make a filter. Still another possibility is to use crosslinked CMC as a substrate for introduction of cationic side groups. Such zwitterionic polymers act as ion exchange polymers, and are effective in removing from water ionic impurities, such as partially oxidized pollutants, perchlorate, lead, cadmium and arsenic. Alternatively, other known or commercially available polymers can be used.

When ozone is used in significant quantities, it may damage and oxidize the polysaccharide based filter media. Then a special ceramic media made by pyrolysing mixtures of low and high molecular weight materials and polymers, especially the sugars and polysaccharide-derived polymers with pre-ceramic materials, or polysaccharide-derived pre-ceramic polymers can be used. On pyrolizing the carbon polymer burns-out leaving ceramic porous media. Examples of pre-ceramic materials are alkoxysilanes like tetra-ethoxysilane, aluminum tetraalkoxide, like aluminum isopropoxide, aluminum haloalkoxide, aluminum tetrahalide, soluble and insoluble silicates, borates, perborates, titanates. Examples of pre-ceramic polysaccharide-derived materials are tetraethoxysilane-cellulose graft-copolymers or blends, aluminum isopropoxide-carboxymethylcellulose grafts, cellulose phosphate, cellulose borate, or blends of such materials, sodium silicate or other alkali metal or alkali earth metal silicates titanates, aluminates,

Sensor and control system 500 to automatically control the operation of the apparatus to purify the air and provide desired indoor temperature and humidity, based on the indication of the sensors, comprising air quality sensors, such as temperature and humidity sensors, carbon dioxide, carbon monoxide, air particulate sensors, water quality sensors, such as temperature, pH, turbidity, oxidation or reduction potential, conductivity. Means to control the water circulation rate, air circulation rate, all tying into the computer and providing inputs for automatic intelligent control of the system through the computer,

Examples of controlled operation through sensors: The carbon dioxide sensor is controlling the fresh air intake rate. The humidity sensor controls the ratio between the water stream going into the dispersion head directly vs. through the heat exchanger 365. The thermostat setting controls the water heater/cooler operation. The air particulate sensor controls the rate of air recirculation. Ozone sensors controls the UV-VIS lights and air ionizer.

Chemical and biological toxins sensors, comprising a variety of sensors, among them the flame ionization detector, and in particular these using UV fluorescence and IR spectroscopy as ways to identify the threats, and these using photo-catalytic and photo-fluorescent media, comprising of titania, vanadium or molybdenum or otherwise doped titania, magnesia, zinc oxide, alumina, apatite, MnO2 micro or nano-particles or nano-fibers, or coatings deposited on the surface of UV-transparent optical glass fiber, or on otherwise shaped support, ozone sensor at the air exit end of the chamber. The sensors feed the data into pattern-recognition software and the heuristic formula, which triggers the alarm and seals the indoors and activates the when threat is detected

A toxic warfare neutralizing agent comprising of alkali or alkaline earth metals oxide, hydroxide, peroxide, percarbonate, persulfate, permanganate, hypochlorite, or ammonium or N-substituted promary, secondary, ternary or quaternary amines or amine oxide, hydroxide, peroxide, percarbonate, persulfate, permanganate, trisodium phosphate, hydrogen peroxide, or organic peroxides or their mixtures, and mixtures with additional surfactants, catalysts, enzymes, stabilizers dispersants and other aids, which are stored in a vessel 231 and released into the air-water chamber by opening valves 232, 233 to water stream when toxic warfare agents are detected.

Scale removing chemical comprising and organic or inorganic acid, preferably comprising of glycolic, acetic, phosphoric or hydrochloric acid or trisodium phosphate,

Ductwork cleaning, deodorizing and disinfecting chemicals, quat disinfectant, comprising of alkyl dimethyl ethylbenzyl ammonium chloride, or alkyl dimethyl benzyl ammonium chloride, or ethyl alcohol, which may be combined with the acrylic latex matrix. For periodic disinfecting of the ducts the water is run hot, and the water particle size small, and the air flow fast, and the mist capturing devices are temporarily disabled, to let the mist containing these chemicals enter the ductwork. Alternatively, ozone released into a ductwork together with water mist will do the same.

One or more vessels 231 for storing a scale removing and cleaning chemical, and a neutralizing agent against the chemical and biological warfare agents connected to a air-water contacting chamber, and released into the chamber by opening valves 232 and 233, and to the water stream when toxic warfare agents are detected, or as part of the routine maintenance.

A cleaning and a toxic warfare neutralizing mode incorporates in one preferred configuration the neutralizer solution, circulated between the neutralizer vessel 231, valve 232, the air-water chamber 200, through the nozzles 270 in the air-water contacting chamber 200, leaving the chamber through the bottom, through valve 233 and pump 234. At that time the outdoor air intake valve 210 is closed, and the water valve to the water holding tank is closed. Such neutralizing loop prevents contamination of indoor air and water.

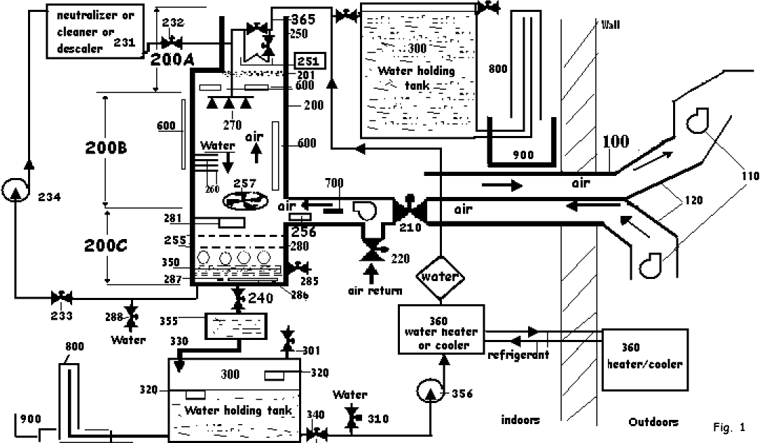

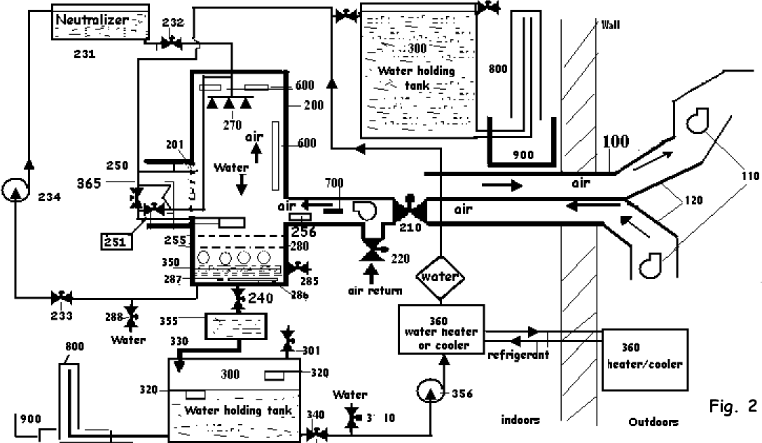

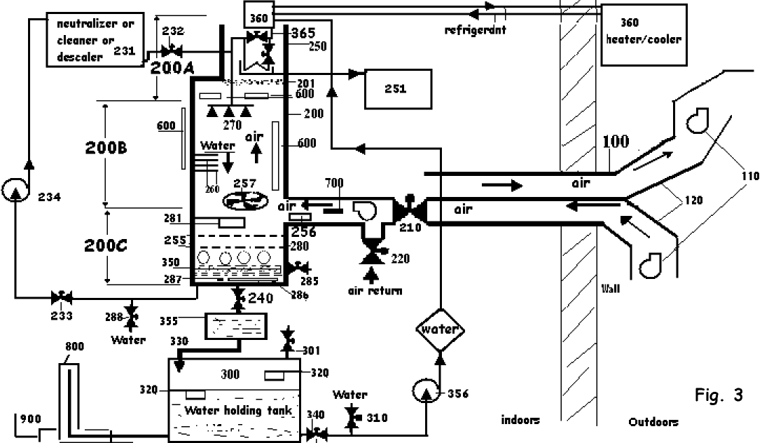

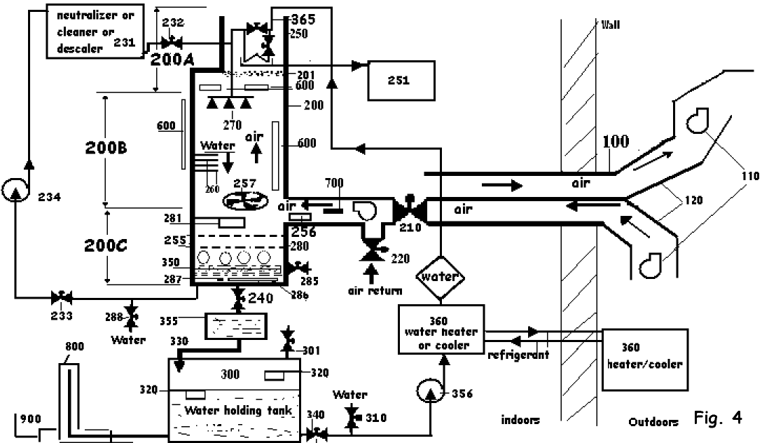

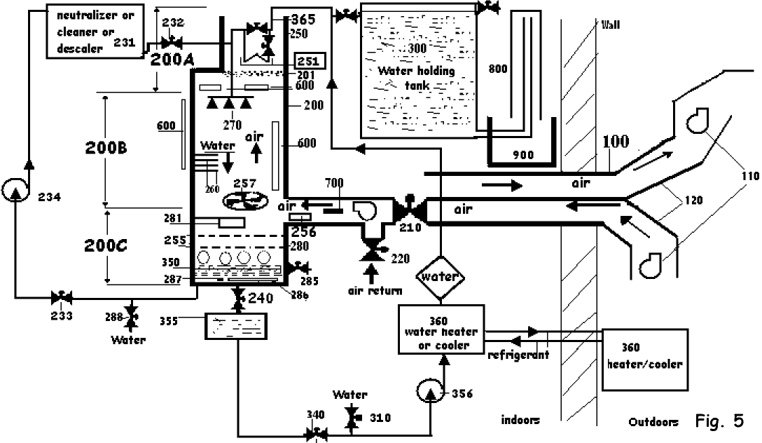

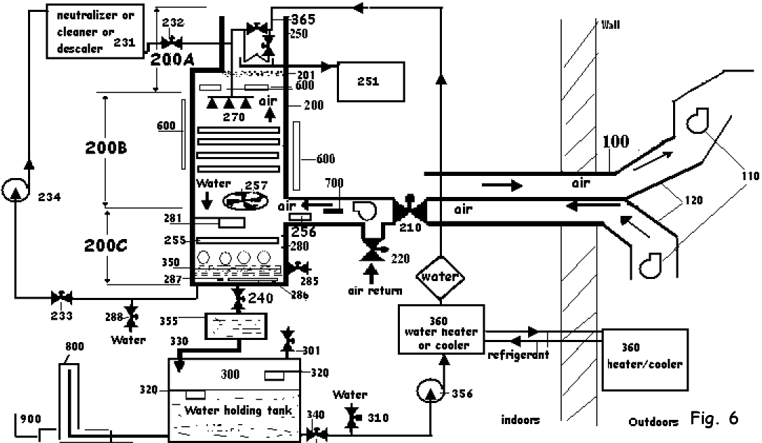

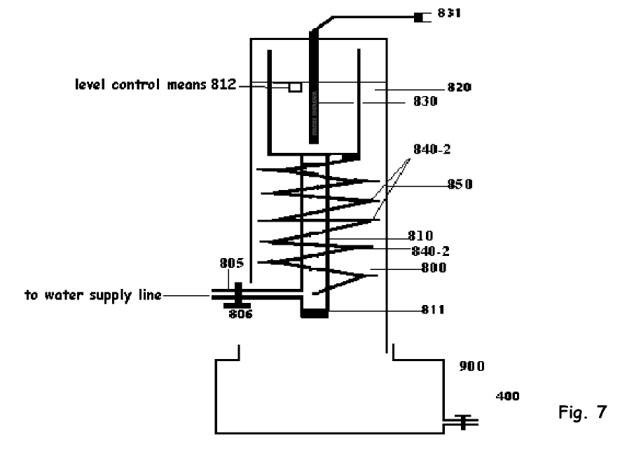

A novel design water distillation apparatus 800, of stand alone type, or attached to the water holding tank 300, to further purify the water for drinking. The apparatus can also be used to purify other liquids. The apparatus or the tank 300 is also connected to the utility water source 310, with means to control the water level in the apparatus or the tank. This tank can also be vented to the atmosphere through the valve 301. This tank 300 and apparatus 800 can alternatively be used as a separate embodiment as an independent free-standing device. See FIG. 1 through 4 for various embodiments. The distillation device comprises a vertical or inclined pipe 810 that is open at the top and closed with removable stopper at the bottom. The pipe 810 is attached near the bottom of the pipe to the tank through pipe 805 establishing two communicating vessels. Alternatively the pipe 810 is directly connected to a water source, and has independent liquid level controls. The pipe 810 is optionally widened 820 at the top, making the top part a kind of a boiling vessel. The tank, the pipes 805 and 810 are therefore forming two communicating vessels, with equilibrium water level in the pipe 810 being the same as in the tank 300. The pipe 810 can be straight, spiral, or any shape, but preferably, the pipe 810 is straight to facilitate cleaning the accumulating scale. The said pipe 810 is either of the same diameter throughout, or is widened 820 at the top, The said pipe 810 has the outer surface of a simple regular pipe, or is shaped or lined with heat conducting rings 840-1, or spirals 840-2, or has curved, spiked, zig-zag, spiral or other shape or combination of shapes for facilitating the heat transfer between the inside and the outside of the pipe, which said pipe 810 is closed at the bottom with a removable plug 811, and which plug can have a wire 831 going through to the heating element 830, A heating element 830 is boiling the water at the top of the pipe, with the vapors escaping over the top of the pipe 810, where they are condensed on the way down on the outside surface of the pipe 810. This establishes a counter-flow heat exchange between the downward moving water vapors which are heating the incoming cold water moving up on the way to be distilled. The heating element is heating the top of the pipe. It is placed inside, or attached on the outside of the top of the pipe 810, and is connected to the electric or gas energy source from above or from below. In one embodiment, the connection to the electricity source is through the bottom of the pipe 810, in another, through the top, in yet another one, through the walls of the pipe. The energy used to heat the water near the top of the pipe 810 can also be microwave, solar rays, or another form of radiation. The inner surface of the pipe is preferably smooth to facilitate cleaning from scale. The outer surface of the pipe 810 is optionally shaped or lined with metal rings 840-1, or preferably spirals 840-2, etc. to facilitate the heat transfer between the inside and outside of the pipe, and to channel the condensed water downwards along the pipe 810, and towards the distillate receiver vessel 900. The outer cover 850, which is closed at the top, and open to the atmosphere at the bottom, and which lets the condensed distilled water out into the vessel 900, and which is preferably made of glass, is enclosing the pipe 810. A slot is cut in the bottom wall of the cover 850 to accommodate the pipe 805 when the cover is lowered in it's position, and to let the wire from for the heating element through. Optionally, the coils around the pipe 810 form such an enclosed vessel, then the enclosure 850 is not needed. A heating element can be a thermoelectric modules are small, solid state, heat pumps that cool, heat and generate power. In function, they are similar to conventional refrigerators in that they move heat from one area to another and, thus, create a temperature differential. A thermoelectric module is comprised of an array of semiconductor couples (P and N pellets) connected electrically in series and thermally in parallel, sandwiched between metallized ceramic substrates. In essence, if a thermoelectric module is connected to a DC power source, heat is absorbed at one end of the device to cool that end, while heat is rejected at the other end, where the temperature rises. This is known as the Peltier Effect. By reversing the current flow, the direction of the heat flow is reversed. A bismuth telluride thermoelectric element consists of a quaternary alloy of bismuth, tellurium, selenium and antimony—doped and processed to yield oriented polycrystalline semiconductors with anisotropic thermoelectric properties. The bismuth telluride is primarily used as a semiconductor material, heavily doped to create either an excess (n-type) or a deficiency (p-type) of electrons. A plurality of these couples are connected in series electrically and in parallel thermally, and integrated into modules. The modules are packaged between metallized ceramic plates to afford optimum electrical insulation and thermal conduction with high mechanical compression strength. Typical modules contain from 3 to 127 thermocouples. Modules can also be mounted in parallel to increase the heat transfer effect or stacked in multistage cascades to achieve high differential temperatures.

A drinking water dispensing outlet 400, which is drawing water from the recirculating system, or from the distillate receiver 900, with means 410 to additionally filter the water during dispensing, and (optionally) means 420 for heating or cooling the drinking water. The drinking water dispensing outlet 400 is connected anywhere in the water circulation path, but preferably to the distillate receiver 900, or to the outflow line from the tank towards the water contacting chamber, F. A sensor and control system 500 to automatically control the operation of the apparatus to purify the air and provide desired indoor temperature and humidity, based on the indication of the sensors, comprising means to control the temperature of the circulating water, thermostat to control the temperature of the indoor air by controlling the temperature of the circulating water in the chamber, means to control the indoor-outdoor air exchange rate, and the ratio between the incoming air stream from outdoors and the recirculation indoors air that goes through the water contacting chamber.

Water Dispersion Modes. The preferred designs are either crossflow (horizontal) or countercurrent (vertical) flow, of which the countercurrent vertical one is the most preferred. In one design the air moves upward through the chamber, and the water downwards. This counterflow design provides a very efficient heat exchange.

In alternative embodiment both air and the water move downwards. In this way the air can be actually pumped by the water stream, through the Venturi effect pipe. (An example of such pipe is a vacuum aspirator, which uses tap water stream to pump air and create vacuum). Moving the water-air through the Venturi effect pipe also creates a good water-air mixing.

Another design is a fountain, with water and air going upwards while mixing and pumping air upwards through the Venturi effect pipe, with water subsequently falling back. Still another arrangement is a cross-flow, where the air moves horizontally through the falling water contacting. Still another design is by filling the water chamber with rocks, especially with limestone, or wood with water flowing or percolating down, and air upwards. Another design is to plant beneficial bacteria or plants in the chamber, which purify the air. Other arrangements and combinations are also possible within the scope of this invention. Each design has its advantages and disadvantages.

Obviously, numerous variations and modifications can be made without departing from the spirit of the present invention. Therefore, it should be clearly understood that the form of the present invention described above and shown in the figures of the accompanying drawings are illustrative only and not intended to limit the scope of the present invention.

1. I claim an apparatus comprising of: a. a chamber for contacting the air with water in presence of electromagnetic energy and catalysts, comprising a water-impermeable enclosure with air intake and air outlet, water intake and water outlet, with at least one water dispersing device or nozzle, which further comprises of, and is part of b. a water circulation loop, comprising of a recirculation pump, at least one water filter, at least one water tank having an inlet and the outlet and a vent with a valve to the atmosphere, one or more means to monitor and control the water level in the tank, a utility water connection, a water heater/cooler, a split valve that splits the water stream in two, with one stream going directly to the water-dispersing nozzles in the chamber, and another stream going through the heat exchanger in the path of the air exiting the chamber, and then to the nozzles in the chamber, thus completing the water circulating loop, c. air purification path comprising an outdoor air intake through the air-to-air heat exchanger connected to the chamber through a vent and a valve, an indoor air intake connected to the chamber through a vent and a valve, or through a three-way valve that controls the amount and the ratio between the outdoors and indoors air entering the said chamber, a vent and a valve for the air exiting the chamber towards indoors or towards the air ductwork, d. means to contain the water droplets or mist within the chamber, located in the chamber air outlet, e. one or more electromagnetic radiation sources to irradiate the water in the chamber, f. baffles, webs, channels or other fillers or porous elements that allow mixing and percolation of water and air, g. Solid photocatalytic elements, h. a mixer to enhance the mixing of air and water or to create a vortex or cyclone movement within the chamber, i. an air ionizer in the chamber air intake path to create an electric charge potential between the incoming air and the water in the chamber, j. flame ionization detector in the chamber air intake and the air outlet, k. electrolysis electrodes in the water path towards the water tank, l. means to convey at least part of the hydrogen and oxygen gases generated during the electrolysis to the flame ionization detectors, m. a heater and cooler means to heat or cool the water flowing from the tank into the air-water contacting chamber, which is located either outside the chamber, or in the path of the air exiting the chamber, n. mineral filtering and percolating filling on the bottom of the chamber to capture particulate impurities, o. a polishing filter system comprising of at least one of the carbon filter, water-permeable membrane or a fiber bed, or an ion exchanging membrane or a fiber bed, with means to regenerate the said ion exchange bed, p. a water distillation apparatus, attached to the water holding tank, q. a drinking water dispensing outlet, r. sensors located at various points in the apparatus, and a control and threat detection system to automatically control the operation of the apparatus, s. at least one vessel for storing a cleaning or scale removing chemical, for ductwork cleaning, deodorizing and disinfecting chemicals, or a neutralizing chemical against the chemical and biological warfare agents, connected to a air-water contacting chamber, and released into the chamber by opening valves to the water stream for cleaning and de-scaling the interior of the chamber, or to clean the air ducts, or when toxic warfare agents are detected, t. a toxic warfare agent neutralizing chemical, u. a scale removing chemical comprising of an organic or inorganic acid, v. duct disinfecting deodorizing bacteristatic, fungistatic mildewstatic, germistatic, and cleaning chemical, w. electric current rectifier, high voltage and low voltage power supplies.

2. a. An apparatus as claimed in claim 1, further defined as having an air-water contacting chamber with a fully or partially reflective coating on the walls, with a door for easy servicing, wherein the chamber outlet is connected to the house ventilation ducts, and the indoor air intake is connected to the return air ducts, means of dispersing or pulverizing the water to create a mist or contacting of water particles within the chamber, comprising of Venturi-effect dispersing head, or an ultrasonic fogging device, or a rotor-stator disperser device, or a device using electrostatic charge to break-up the spray particles, or a perforated “shower” head, dispersing the water into macro, micro or nano-particles, or macro, micro or nano-films on the surface of the solid media, b. wherein the heat exchanger in the path of the air exiting the chamber has a capacity to transfer to the air from about 5 to 95 percent of the heat carried by circulating water, with the said heat exchanger also having a provision for collecting the water condensate into a separate vessel for distilled water, c. outdoor air intake through the air-to-air heat exchanger of counter-flow design, d. means to contain the water droplets or mist within the chamber, of electrostatic precipitator or a loosely woven mesh, e. electromagnetic radiation sources comprising one or more UV-Visible light or electron beam, or electric arc, or X-rays or gamma-rays to irradiate the water in the chamber, f. devices facilitating water and air contact made as macro, micro or nano-particles or macro, micro or nano-fibers, or coatings deposited on the surface of the UV-transparent or reflecting media such as optical glass or other type of hollow or solid fiber, silver, copper wires, or on otherwise shaped support, and shaped in loosely packed webs, coils, woven as cloth, layered, andomly packed, or any other three-dimensional shape, or branching off from the central elongated tube containing the light source, or made as free hanging beads suspended from a string or free floating beads, or randomly or orderly packed, g. devices that facilitate contact of water with air, made of photo-catalytic or fluorescent media, comprising of titania, or vanadium or molybdenum or otherwise doped titania, magnesia, zinc oxide, alumina, apatite, limestone, MnO2, aluminosilicate, clay, k. electrolysis electrodes made of graphite, or silver or copper, or coated with silver or copper, shaped as horisontal mesh plates, or as a cylinder around a vertical rod or as several concentric cylinders with alternating polarity, n. a water filtering system comprising of at least one water filter for filtering out particulate, a back-flushing system for the particulate filter, and at least one water filter for filtering out other impurities, wherein the water filter for filtering out particulate is comprising of from 0 to 100% coarse sand, from 0 to 100% or gravel, and from 0 to 100% crushed limestone, calcium carbonate, or calcite, o. a water filter for filtering out other impurities comprising of at least one of the carbon filter, or a water-permeable reverse osmosis membrane or a fiber bed, or an ion exchanging membrane or a fiber bed, p. a water distillation apparatus, attached to the water holding tank, q. a drinking water dispensing outlet, which is drawing water from the circulating system, or from the distillate receiver, with means to additionally filter the water during dispensing, such as reverse osmosis unit, and means for heating or cooling the drinking water, r. a control and a threat detection system to automatically control the operation of the apparatus to purify the air and provide desired indoor temperature and humidity based on the indication of the sensors, comprising sensors, data processors, actuators, comprising of means to switch the water circulation loop from normal to emergency mode when threat is detected, to isolate the storage tank from the source of the threat, to introduce the neutralizing agents in the water, and circulating such water through a separate neutralization loop, and means to transmit the threat alarm to a remote location, means to control the temperature of the circulating water, thermostat to control the temperature of the indoor air by heating or cooling the water before it enters the chamber, means to control the indoor-outdoor air exchange rate, and the ratio between the incoming air stream from outdoors and the recirculation indoors air that goes through the water contacting chamber, means to control the water circulation rate, means to control the ratio of water entering the water dispersing devices 270 directly, or through the heat exchanger coils, sensors, comprising flame ionization detector, pH and conductivity sensors, IR and fluorescence sensors, air quality sensors, such as temperature and humidity sensors, carbon dioxide, carbon monoxide, ozone, air particulate sensors, water quality sensors, such as temperature, pH, turbidity, oxidation or reduction potential, conductivity, chemical and biological toxins sensors, using UV fluorescence, IR spectroscopy or other as ways to identify the threats, t. a toxic warfare neutralizing agent comprising alkali or alkaline earth metals oxide, hydroxide, peroxide, percarbonate, persulfate, permanganate, or ammonium or N-substituted promary, secondary, ternary or quaternary amines or amine oxide, hydroxide, peroxide, percarbonate, persulfate, permanganate, or organic peroxides or their mixtures, and mixtures with additional surfactants, catalysts, enzymes, stabilizers, dispersants and other aids, u. a scale removing chemical comprising of an organic or inorganic acid.

3. a. An apparatus as claimed in claim 1, further defined as having the contents of the chamber assembled from the individual rectangular stationary trays, or round rotating modular trays, wherein the heat exchanger in the path of the air exiting the chamber has a capacity to transfer to the air from about 25 to 75 percent of the heat carried by circulating water, a back-flushing system for the particulate filter, comprising of a floating lever that activates the back-flushing cycle when the water raises above the pre-set level, a mechanism that closes the valve from the chamber to the water tank, and opens the utility water connection to the bottom of the chamber and the drain valve, a vibrator, to vibrate the particulate filter during the back-flushing, a heater to heat the water during back-flushing, a valve to remove the flush water, the water filter containing activated carbon, and an ion exchanging membrane or a fiber bed, with means to regenerate the said ion exchange bed electrolysis electrodes 255, made of silver, copper or other metal that produce antiseptic ions when dissolved, sensors: flame ionization detector, UV fluorescence, IR spectroscopy or other as ways to identify the threats, and in particular these using photo-catalytic media, comprising of titania, doped titania, magnesia, zinc oxide, alumina, apatite, MnO2 micro or nano-particles or nano-fibers, or coatings deposited on the surface of UV-transparent optical silica or glass fiber, or metal fiber, a toxic agents neutralizing chemical comprising alkali or alkaline earth metals oxide, hydroxide, peroxide, percarbonate, persulfate, permanganate, hypochlorite, or ammonium percarbonate, persulfate, permanganate, trisodium phosphate, hydrogen peroxide, and mixtures with additional surfactants, catalysts, enzymes, stabilizers dispersants and other aids, a scale removing chemical comprising of glycolic, acetic, phosphoric, hydrochloric acid, a duct disinfecting chemical comprising ethyl alcohol, and quat disinfectant.

4. a. An apparatus as claimed in claim 1, further defined as having the solid contact media contents of the chamber assembled from the individual round horizontal modular trays and means to spin them around the vertical axis to facilitate mixing air and water, and the material in the tray is shaped for propelling air upwards, and furthermore, the trays are rotating by the power of the water running through the chamber, or the water dispersing device is rotating, or both,

5. A distillation apparatus, suitable for water or other liquids, either free standing, or attached to a liquid holding vessel or tank, which apparatus or the apparatus and the tank are used either as a separate and independent stand-alone device, or as a part of another apparatus like the distillation apparatus 800 and the tank 300 in claim 1, comprising of a vertical or inclined pipe 810, which said pipe 810 is open at the top and closed at the bottom with a removable plug 811, which said pipe is connected near the bottom to the liquid supplying source, or to the tank, establishing two communicating vessels with the tank, wherein the liquid level controlling means are established in the pipe 810 or in the tank 300, which said pipe 810 is either of the same diameter throughout, or is widened 820 at the top, and which said pipe 810 has the outer surface of a simple regular pipe, or is shaped or lined with heat conducting rings 840-1, or spirals 840-2, or has curved, spiked, broken, spiral or other shape or combination of shapes for facilitating the heat transfer between the inside and the outside of the pipe, and which removable plug 811 can have a wire 831 going through to the heating element 830, heating means 830 to boil the liquid at the top part 820 of the pipe 810, with the vapors escaping over the top of the pipe and down, where they are condensed on the way down on the outside surface of the pipe 810, establishing a counter-flow heat exchange between the downwardly moving liquid vapors on the outside of the pipe 810, and the upwardly moving cold liquid inside the pipe from the liquid source or from the tank, the outer cover 850 enclosing the pipe 810, with an air gap between the cover and the top and the walls of the pipe 810, with said cover having an upper end, and a lower end, with the upper end closed to the atmosphere, which can have a sealed hole for the wire that leads to the heating element 830 from above or from the side or from the bottom, and said cover is open to the atmosphere at the lower end, and lets the condensed distilled liquid fall into the distillate receiver vessel 900, which said cover has a slot at the lower part to accommodate the pipe 805 when the cover is lowered in position.

6. An apparatus as disclosed in claim 5, wherein the heating means comprise either infra-red, solar, microwave, or other radiation heat source, or an electric resistance heating element, or thermoelectric Peltier Effect element, with wires 831 supplying electrical energy either through the top, or through the bottom, or through the sides of the cover 850.

7. A method comprising of (a) exchanging the outdoors and indoors air while efficiently exchanging the heat, with the outdoors air moving indoors and indoors air outdoors through the counter-flow heat exchanger, (b) filtering the incoming outdoors air by passing it through the water contacting chamber, which traps the particulate pollutants in water droplets, and at the same time purifies the indoors air by (c) recirculating it through the same chamber, (d) disinfecting and oxidizing the pollutants by irradiating with the UV light the water and air mixture in the contacting chamber and (e) disinfecting and oxidizing the pollutants by electrolyzing the water in the contacting chamber and (f) by percolating the air-water mixture through the limestone bed in the chamber, (g) heating or cooling the indoor air through controlling the temperature of the circulating water in the chamber, (h) humidifying or dehumidifying the indoor air through controlling the temperature of the circulating water in the chamber, and through controlling the ratio of the water flowing directly to the chamber to the water flowing to the chamber through the heat exchanger placed on the exit path of the air flowing from the chamber, (i) condensing the water from the air by cooling the water, and (j) converting it into clean potable water through circulating it through the water filter system along with the rest of the water, between the water holding tank and the water contacting chamber, thus continuously purifying the water, (k) storing the water in the water holding tank, and (l) removing particulate through the sand and limestone filter, and toxic impurities, and the oxidized by-products of pollutants by filtering through the ion exchange media, and by distilling the water through a distillation apparatus 800, (m) recycling the filter by back-flushing, (n) cleaning and disinfecting the air ducts by periodically introducing hot water mist of small particle size, ethyl alcohol and quat disinfectant, or hot water mist and ozone, or both in sequence into the air ducts, and (o) isolating the water tank and closing the outdoor air supply when threat is detected, and running the neutralizing solution through the air-water contacting chamber.

8. Ceramic porous media made by pyrolyzing mixtures of the sugars or polysaccharide derived polymers with pre-ceramic materials with pre-ceramic materials, wherein the sugars or polysaccharide based pre-cursors are first reacted or blended with pre-ceramic reagents, then the resulting graft copolymer or blend is sintered.

9. Materials of claim 8 wherein the polysaccharide derived materials are sugar, glucose, glycerol, cellulose, carboxymethylcellulose, amino-functional cellulose, cellulose phosphate, cellulose borate, chitin, chitosan, and the pre-ceramic materials are alkoxysilanes, halosilanes, haloalkoxysilanes, such as tetraethoxysilane, tetrachlorosilane, polysiloxane, alkali or alkali earth metal silicate, alkali or alkali earth metal aluminate, alkali or alkali earth metal titanate, alkali or alkali earth metal borate and perborate, alkali metal or alkali earth phosphate, alkoxyaluminates, alkoxytitanates, aluminum halides, titanium halides, aluminum alkoxyhalides, titanium alkoxyhalides, or blends of such materials and blends with other materials.
